(19) United States
(12) Patent Application Publication
(10) Pub. No.: US 2022/0139102 A1
(43) Pub. Date: May 5, 2022

(54) FINGERPRINT RECOGNITION METHOD FOR DISPLAY PANEL, DISPLAY PANEL, AND DISPLAY APPARATUS

(71) Applicant: Shanghai Tianma Micro-Electronics Co.,Ltd., Shanghai (CN)

(72) Inventors: Bo ZHANG, Shanghai (CN); Qijun YAO, Shanghai (CN)

(73) Assignee: Shanghai Tianma Micro-Electronics Co.,Ltd., Shanghai (CN)

(21) Appl. No.: 17/578,696

(22) Filed: Jan. 19, 2022

(30) Foreign Application Priority Data
Oct. 8, 2021 (CN) 202111170868.2

(51) Int. Cl. G06V 40/13; G09G 3/20

(52) U.S. Cl. CPC G06V 40/1306; G09G 3/20; G09G 2310/08; G09G 2310/061; G09G 2300/0842

(57) ABSTRACT

A fingerprint recognition method for a display panel, a display panel, and a display apparatus are provided. A driving cycle includes n excitation storage periods and a read period. Each excitation storage period includes an excitation period and a storage period. The fingerprint recognition method includes: during the excitation period, converting, by the ultrasonic sensor, an excitation electrical signal into an ultrasonic signal, and radiating the ultrasonic signal toward a finger; during the storage period, converting, by the ultrasonic sensor, an ultrasonic signal reflected by the finger into a reflection electrical signal and transmitting the reflection electrical signal to the first node, and transmitting, by the control sub-circuit, a pull-up signal to the first node, and transmitting a signal of the first node to the second node; and during the reading period, transmitting, by the read sub-circuit, a signal reflecting a voltage size of second node, to read signal line.

### CROSS-REFERENCE TO RELATED APPLICATION

The present application claims priority to Chinese Patent Application No. 202111170868.2, filed on Oct. 8, 2021, the content of which is incorporated herein by reference in its entirety.

### TECHNICAL FIELD

The present disclosure relates to the field of display technologies, and, particularly, relates to a fingerprint recognition method for a display panel, a display panel, and a display apparatus.

### BACKGROUND

In recent years, with the rapid development of display technologies, display apparatuses with biometric recognition function have gradually entered people's life and work. Fingerprint recognition technology has been widely used in unlocking and secure payment because fingerprints have characteristic of unique identity.

Ultrasonic fingerprint recognition, as a new fingerprint recognition technology, has become a hot spot in research. However, in the related art, the accuracy of ultrasonic fingerprint recognition needs to be further improved.

### SUMMARY

In a first aspect of the present disclosure, a fingerprint recognition method for a display panel is provided. The display panel includes a fingerprint recognition circuit. The fingerprint recognition circuit includes a first node, a second node, an ultrasonic sensor electrically connected to an excitation signal line and the first node, a control sub-circuit electrically connected to the first node and the second node, and a read sub-circuit electrically connected to the second node and a read signal line. A driving cycle for fingerprint recognition of the display panel includes n excitation storage periods and a read period. The n excitation storage periods are executed prior to the read period, where n is a positive integer greater than or equal to 2. Each of the n excitation storage periods includes an excitation period and a storage period. The fingerprint recognition method includes: during the excitation period of the excitation storage period, converting, by the ultrasonic sensor, an excitation electrical signal transmitted by the excitation signal line into an ultrasonic signal, and radiating the ultrasonic signal toward a finger; during the storage period of the excitation storage period, converting, by the ultrasonic sensor, an ultrasonic signal reflected by the finger into a reflection electrical signal, transmitting, by the ultrasonic sensor, the reflection electrical signal to the first node, transmitting, by the control sub-circuit, a pull-up signal to the first node, and transmitting, by the control sub-circuit, a signal of the first node to the second node; and during the reading period, transmitting, by the read sub-circuit, a signal that reflects a size of a voltage of the second node, to the read signal line.

In a second aspect of the present disclosure, a display panel is provided. The display panel includes a fingerprint recognition circuit. The fingerprint recognition circuit includes a first node, a second node, an ultrasonic sensor, a control sub-circuit, and a read sub-circuit. The ultrasonic sensor is electrically connected to both an excitation signal line and the first node. The ultrasonic sensor is configured to convert an excitation electrical signal transmitted by the excitation signal line into an ultrasonic signal and radiate the ultrasonic signal toward a finger, and convert an ultrasonic signal reflected by the finger into a reflection electrical signal and transmit the reflection electrical signal to the first node. The control sub-circuit is electrically connected to a first control signal line, a pull-up signal line, the first node, and the second node. The control sub-circuit is configured to transmit a pull-up signal to the first node and transmit a signal of the first node to the second node. A read sub-circuit is electrically connected to the second node, a first fixed potential signal line, the read control signal line, and the read signal line. The read sub-circuit is configured to transmit a signal that reflects a size of a voltage of the second node, to the read signal line.

In a third aspect of the present disclosure, a display apparatus is provided. The display apparatus includes the display panel provided in the first aspect, and a processor electrically connected to the read signal line. The processor is configured to recognize fingerprints based on a signal read by the read signal line.

### BRIEF DESCRIPTION OF DRAWINGS

In order to more clearly illustrate technical solutions of embodiments of the present disclosure, the accompanying drawings used in the embodiments are briefly described below. The drawings described below are merely some of the embodiments of the present disclosure. Based on these drawings, those skilled in the art can obtain other drawings.

FIG. 1 is a schematic diagram showing ultrasonic signal transmission in the related art;

FIG. 2 is a schematic diagram showing a display panel according to an embodiment of the present disclosure;

FIG. 3 is a schematic diagram showing a fingerprint recognition circuit according to an embodiment of the present disclosure;

FIG. 4 is a sequence diagram corresponding to FIG. 3 according to an embodiment of the present disclosure;

FIG. 5 is a schematic diagram showing a fingerprint recognition circuit according to an embodiment of the present disclosure;

FIG. 6 is a sequence diagram corresponding to FIG. 5 according to an embodiment of the present disclosure;

FIG. 7 is a cross-sectional view corresponding to FIG. 2 along A1-A2 according to an embodiment of the present disclosure;

FIG. 8 is a signal diagram showing a reflection electrical signal according to an embodiment of the present disclosure;

FIG. 9 is a schematic diagram showing a fingerprint recognition circuit according to another embodiment of the present disclosure;

FIG. 10 is a sequence diagram corresponding to FIG. 9 according to an embodiment of the present disclosure;

FIG. 11 is a schematic diagram showing a fingerprint recognition circuit according to another embodiment of the present disclosure;

FIG. 12 is a schematic diagram showing a fingerprint recognition circuit according to another embodiment of the present disclosure; and

FIG. 13 is a schematic diagram showing a display apparatus according to an embodiment of the present disclosure.

### DESCRIPTION OF EMBODIMENTS

In order to better understand technical solutions of the present disclosure, the embodiments of the present disclosure are described in detail with reference to the drawings.

It should be clear that the described embodiments are merely some of the embodiments of the present disclosure rather than all the embodiments. All other embodiments obtained by those skilled in the art shall fall into the protection scope of the present disclosure.

The terms used in the embodiments of the present disclosure are merely for the purpose of describing specific embodiment, rather than limiting the present disclosure. The terms “a”, “an”, “the” and “said” in a singular form in an embodiment of the present disclosure and the attached claims are also intended to include plural forms thereof, unless noted otherwise.

It should be understood that the term “and/or” used in the context of the present disclosure is to describe a correlation relation of related objects, indicating that there can be three relations, e.g., A and/or B can indicate only A, both A and B, and only B. In addition, the symbol “/” in the context generally indicates that the relation between the objects in front and at the back of “/” is an “or” relationship.

It should be understood that although the terms ‘first’ and ‘second’ can be used in the present disclosure to describe nodes, these nodes should not be limited to these terms. These terms are used only to distinguish the nodes from each other. For example, without departing from the scope of the embodiments of the present disclosure, a first node can also be referred to as a second node. Similarly, the second node can also be referred to as the first node.

Before describing the technical solutions provided by the present disclosure, the problems existing in the related art will be firstly explained.

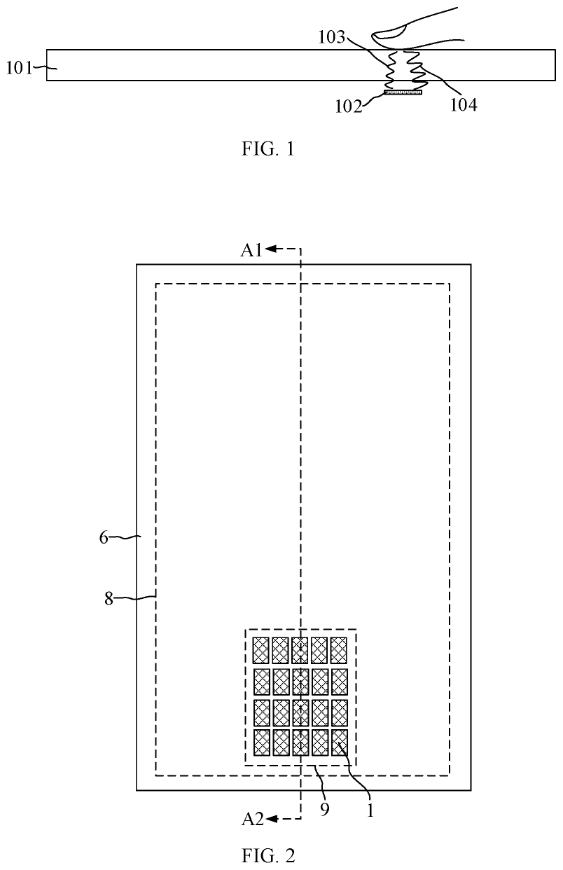

FIG. 1 is a schematic diagram showing ultrasonic signal transmission in the related art. As shown in FIG. 1, a display panel includes a display module 101 and an ultrasonic sensor 102. When the display panel performs fingerprint recognition, the ultrasonic sensor 102 is excited by an excitation electrical signal. The ultrasonic sensor 102 converts the excitation electrical signal into an excitation ultrasonic signal 103. The excitation ultrasonic signal 103 transmits through the display module 101 and radiates toward a finger. After the excitation ultrasonic signal 103 reaches the finger, it will be reflected, and a reflection ultrasonic signal 104 is reflected back transmits through the display module 101 again and reaches the ultrasonic sensor 102. The ultrasonic sensor 102 converts the refection ultrasonic signal 104 into a detection electrical signal.

When the excitation ultrasonic signal 103 reaches the surface of the finger, since fingerprint valleys and fingerprint ridges have different contact surfaces with the display module 101, the amplitudes of the reflection ultrasonic signal 104 reflected from the fingerprint valleys and fingerprint ridges are different. Correspondingly, the signal intensity of the detection electrical signals converted by the reflection ultrasonic signal 104 is also different, and the fingerprint valley and the fingerprint ridge are determined by judging the signal intensity of the detection electrical signal.

In an ideal state, the excitation electrical signal excites the ultrasonic sensor 102 for a sufficient duration of time. The ultrasonic sensor 102 can radiate the excitation ultrasonic signal 103 with a sufficient number of pulses to the finger, so that the reflection ultrasonic signal 104 that is reflected back to the ultrasonic sensor 102 also has a sufficient number of effective pulses. In this way, the signal intensity of the detection electrical signal converted according to the reflection ultrasonic signal 104 can reach a standard intensity of the detection electrical signal corresponding to the fingerprint valleys or fingerprint ridges.

However, in practical application, under the condition of a constant sound velocity of the ultrasonic signal, a total duration of the process in which the ultrasonic signal is radiated by the ultrasonic sensor 102 and returns to the ultrasonic sensor 102 will be limited by a stacking thickness of the display module 101. The thinner the module 101, the shorter the total duration of ultrasonic signal transmission.

In order to achieve thin display apparatuses, the display module 101 generally has a thickness smaller than 500 μm. Based on such thickness of the module, the total duration of ultrasonic signal transmission is only within 400 ns, which leads to a shorter excitation duration of the excitation electrical signal for the ultrasonic sensor 102. In this way, the number of cycles of the excitation electrical signal during the excitation process is small. Correspondingly, the number of effective pulses of the radiated excitation ultrasonic signal 103 and the reflection ultrasonic signal 104 reflected back is also small, resulting in that the intensity of the detection electrical signal converted by the reflection ultrasonic signal 104 cannot reach the standard intensity corresponding to the fingerprint valley or fingerprint ridge, and thus causing recognition errors.

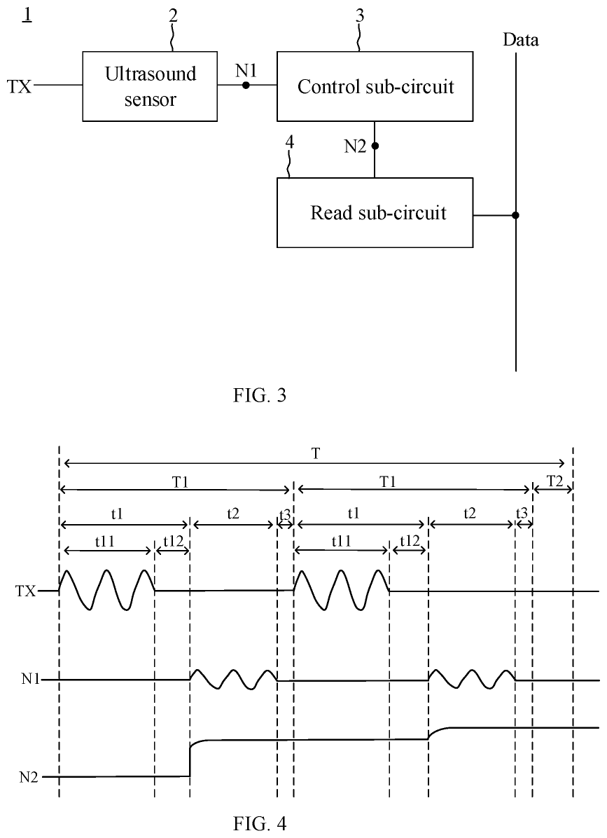

FIG. 2 is a schematic diagram showing a display panel according to an embodiment of the present disclosure, and FIG. 3 is a schematic diagram showing a fingerprint recognition circuit according to an embodiment of the present disclosure. The present disclosure provides a fingerprint recognition method for a display panel, as shown in FIG. 2 and FIG. 3, the display panel applying the fingerprint recognition method includes a fingerprint recognition circuit 1. The fingerprint recognition circuit 1 includes a first node N1, a second node N2, an ultrasonic sensor 2, a control sub-circuit 3, and a read sub-circuit 4. The ultrasonic sensor 2 is electrically connected to an excitation signal line TX and the first node N1. The control sub-circuit 3 is electrically connected to the first node N1 and the second node N2. The read sub-circuit 4 is electrically connected to the second node N2 and a read signal line Data.

FIG. 4 is a sequence diagram corresponding to FIG. 3 according to an embodiment of the present disclosure. As shown in FIG. 4, a driving cycle T for fingerprint recognition of the display panel includes n excitation storage periods T1s and a read period T2. The n excitation storage periods T1s are prior to the read period T2, where n is a positive integer greater than or equal to 2. The excitation storage period T1 includes an excitation period t1 and a storage period t2.

The fingerprint recognition method provided by an embodiment of the present disclosure includes following steps.

During the excitation period t1 of the excitation storage period T1, the ultrasonic sensor 2 converts an excitation electrical signal transmitted by the excitation signal line TX into an ultrasonic signal and radiates the ultrasonic signal toward a finger.

During the storage period t2 of the excitation storage period T1, the ultrasonic sensor converts the ultrasonic signal reflected by the finger into a reflection electrical signal and transmits the reflection electrical signal to the first node N1; and the control sub-circuit 3 transmits a pull-up signal to the first node N1, and transmits the signal of the first node N1 to the second node N2.

During the reading period T2, the read sub-circuit 4 transmits a signal that reflects a size of a voltage of the second node N2, to the read signal line Data.

In an embodiment of the present disclosure, one driving cycle T for fingerprint recognition of the display panel includes at least two excitation storage periods T1s. During each excitation storage period T1, the ultrasonic sensor 2 is excited once by the excitation electrical signal, so that the ultrasonic sensor 2 radiates an ultrasonic signal to the finger once, and stores a reflection electrical signal once at the second node, in which the reflection electrical signal is converted by the control sub-circuit 3 from the ultrasonic signal reflected back.

In an embodiment of the present disclosure, during a first excitation storage period T, a first excitation is performed by using the excitation electrical signal, the control sub-circuit 3 controls the reflection electrical signal generated by the first excitation to be stored in the second node N2, and performs a first charge on the second node N2; during a second excitation storage period T1, a second excitation is performed by using the excitation electrical signal, the control sub-circuit 3 controls the reflection electrical signal generated by the second excitation to perform a superimposition storage on the second node N2, and performs a second charge on the second node N2; . . . ; and so on, until the reflection electrical signal generated by the n^{th} excitation performs the n^{th} charge on the second node N2.

Based on the above driving method, multiple sets of excitation electrical signals excite the ultrasonic sensor 2 multiple times in one driving period T, so that the second node N2 can be accumulatively charged using the reflection electrical signals generated multiple times. In this way, even if a single excitation time of the excitation electrical signal is too short to obtain low intensity of the reflection electrical signal generated by a single excitation, the second node N2 can still reach a higher potential after multiple accumulative charging, so that the final signal intensity of the second node N2 reaches the standard intensity corresponding to fingerprint valleys or fingerprint ridges, and the fingerprint valleys and the fingerprint ridges can be accurately detected according to the magnitude of the potential of the second node N2, thereby improving the fingerprint recognition accuracy.

In other words, the fingerprint recognition accuracy in the embodiments of the present disclosure is no longer limited by the thickness of the display module, and even if the solutions of the embodiments of the present disclosure are applied to an ultra-thin display apparatus, higher recognition accuracy can be achieved. Therefore, the embodiments of the present disclosure are more suitable for fingerprint recognition of ultra-thin display apparatuses. This design concept is consistent with the current design concept of thin display apparatuses, and has a good application prospect.

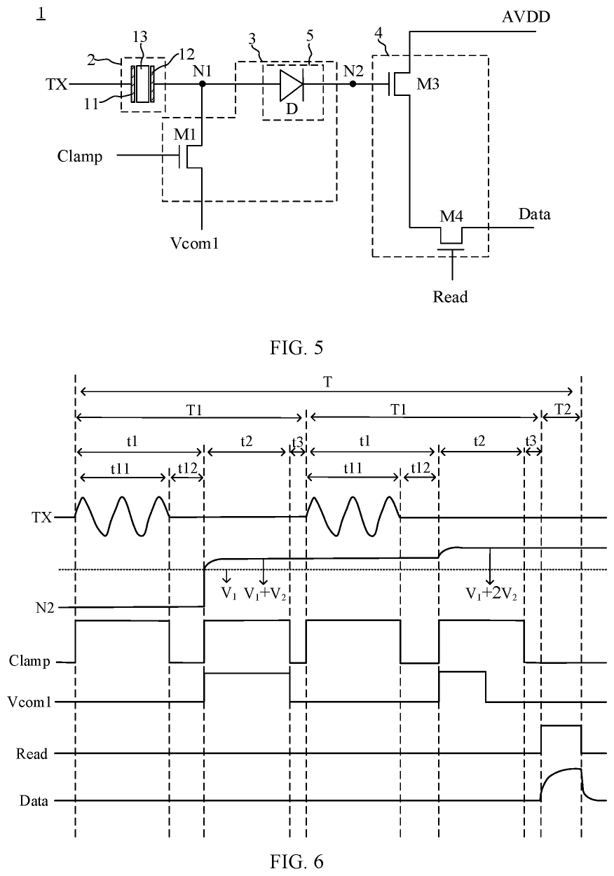

Taking the circuit structure of the fingerprint recognition circuit 1 shown in FIG. 5 as an example, the working principle of the fingerprint recognition of the display panel will be described in detail below.

FIG. 5 is a schematic diagram showing a fingerprint recognition circuit according to an embodiment of the present disclosure. As shown in FIG. 5, the ultrasonic sensor 2 includes a first electrode 11, a second electrode 12, and a piezoelectric layer 13. The first electrode 11 is electrically connected to an excitation signal line TX. The second electrode 12 is electrically connected to the first node N1. The piezoelectric layer 13 is located between the first electrode 11 and the second electrode 12.

The control sub-circuit 3 includes a first transistor M1 and a communication control structure 5. A control electrode of the first transistor M1 is electrically connected to a first control signal line Clamp, a first electrode of the first transistor M1 is electrically connected to a pull-up signal line Vcom1, and a second electrode of the first transistor M1 is electrically connected to the first node N1. The communication control structure 5 is electrically connected between the first node N1 and the second node N2.

The read sub-circuit 4 includes a third transistor M3 and a fourth transistor M4. A control electrode of the third transistor M3 is electrically connected to the second node N2, and a first electrode of the third transistor M3 is electrically connected to a first fixed potential signal line AVDD. A control electrode of the fourth transistor M4 is electrically connected to a read control signal line Read, a first electrode of the fourth transistor M4 is electrically connected to the second electrode of the third transistor M3, and a second electrode of the fourth transistor M4 is electrically connected to a read signal line Data.

FIG. 6 is a sequence diagram corresponding to FIG. 5 according to an embodiment of the present disclosure. As shown in FIG. 6, during the excitation period t1 of the excitation storage period T1, an excitation signal line TX provides an excitation electrical signal to the first electrode 11 of the ultrasonic sensor 2, and the first transistor M1 is turned on under a turn-on signal provided by the first control signal line Clamp, a low-potential driving signal provided by the pull-up signal line Vcom1 is transmitted to the first node N1 (the second electrode 12 of the ultrasonic sensor 2) through the turned-on first transistor M1. Upon driving by the first electrode 11 and the second electrode 12, the piezoelectric layer 13 of the ultrasonic sensor 2 converts the excitation electrical signal transmitted by the excitation signal line TX into an ultrasonic signal, and radiates it toward the finger.

During the storage period t2 of the excitation storage period T1, the first transistor M1 is turned on under the turn-on signal provided by the first control signal line Clamp, and the pull-up signal provided by the pull-up signal line Vcom1 passes through the first transistor M1 turned on is transmitted to the first node N1, and the potential of the first node N1 is pulled up. The piezoelectric layer 13 of the ultrasonic sensor 2 converts the ultrasonic signal reflected back by the finger into a reflection electrical signal, and transmits it to the first node N1. The communication control structure 5 transmits the signal of the first node N1 to the second node N2. The signal transmitted by the communication control structure 5 to the second node N2 includes a reflection electrical signal and a pull-up signal.

During the storage period t2, the pull-up signal is configured to pull up the potential of the second node N2 within a reasonable range, so that the gate potential of the third transistor M3 satisfies: V_{gs}>Vₜₕ, and V_{ds}>V_{gs}−Vₜₕ, thereby controlling the third transistor M3 to be in a saturation state. According to the saturation characteristics of the transistor, it can be concluded that the source-drain current I_{ds} of the third transistor M3 is independent from the source-drain voltage V_{ds}, and increases only with the increase of the gate-source voltage V_{gs}. In this situation, when the potential of the second node N2 is high, the gate-source voltage V_{gs} of the third transistor M3 is large. Correspondingly, the current transmitted from the third transistor M3 to the fourth transistor M4 is large. Subsequently, when the fourth transistor M4 is turned on in the reading period T2, the intensity of the signal reflecting the size of the voltage of the second node N2 and read by the read signal line Data is relatively large. When the potential of the second node N2 is low, the gate-source voltage V_{gs} of the third transistor M3 is small, and accordingly, the current transmitted from the third transistor M3 to the fourth transistor M4 is also small, so that the intensity of the signal reflecting the size of the voltage of the second node N2 and read by the read signal line Data is small.

During the reading period T2, the fourth transistor M4 is turned on under the turn-on signal provided by the reading control signal line Read, and M4 transmits a signal that reflects a size of the voltage of the second node N2, to the read signal line Data.

In an embodiment of the present disclosure, the reflection electrical signal converted by the ultrasonic signal is not directly used to pull up the potential of the second node N2 to the potential required for the third transistor M3 to be in a saturation state, but a pull-up signal is used alone to pull up the potential of the second node N2 to the potential required for the third transistor M3 to be in a saturation state. In this way, the transistor state of the third transistor M3 is independent from the magnitude of the reflection electrical signal fed back, thereby achieving a higher control reliability of the working state of the third transistor M3.

In an embodiment of the present disclosure, referring to FIG. 5 and FIG. 6, the communication control structure 5 includes a diode D, and when the pull-up signal is transmitted to the second node N2, the potential of the second node N2 is pulled up to V₁, V₁=V_{COM1}−V_{M1}−V_{D}, where V_{COM1} denotes a pull-up potential of the pull-up signal, V_{M1} denotes a source-drain voltage of the first transistor M1, and V_{D} denotes a forward turn-on voltage of the diode D. After the reflection electrical signal is transmitted to the second node to charge the second node once, the potential change of the second node is V₂.

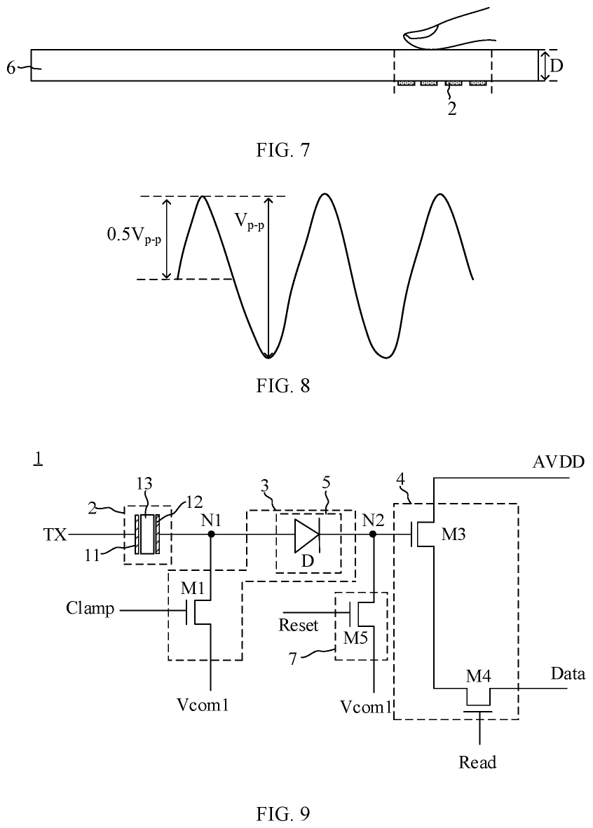

FIG. 7 is a cross-sectional view corresponding to FIG. 2 along A1-A2 according to an embodiment of the present disclosure. In an embodiment of the present disclosure, as shown in FIG. 7, the display panel further includes a display module 6. The ultrasonic sensor 2 is located at a side of the display module 6 facing away from a light-emitting direction of the display panel. During one excitation storage period T1, a duration m1 of the excitation period t1 satisfies m1≥2D/V, where D denotes a thickness of the display module 6, and V is a speed at which the ultrasonic signal is transmitted in the display module 6.

It can be understood that the ultrasonic signal needs to pass through the display module 6 when being transmitted between the ultrasonic sensor 2 and the finger, and a duration for the ultrasonic signal to pass through the display module 6 once is D/V. When the thickness D of the display module 6 is constant, by making the duration of the excitation period t1 during each excitation storage period T1 be greater than or equal to 2D/V, the duration of the excitation period t1 is at least greater than a total duration of the ultrasonic signal from radiating to reflecting back to the ultrasonic sensor 2, so that the ultrasonic signal reflected back can enter the storage period t2 after completely reaches the ultrasonic sensor 2, thereby increasing the signal intensity of the reflection electrical signal generated by a single excitation.

In an embodiment of the present disclosure, the excitation electrical signal and the reflection electrical signal are both sine wave signals, for example, the excitation electrical signal is a sine wave with an amplitude of several tens of volts and a frequency of several MHz, N×V₀≥0.5Vₚ₋ₚ, where N is a total number of the sine wave cycles of the reflection electrical signal during the n excitation and storage periods T1s, and V₀ denotes the voltage variation of the second node N2 when the sine wave with a single cycle in the reflection electrical signal is transmitted to the second node N2, and in combination with the signal schematic diagram showing the reflection electrical signal shown in FIG. 8, Vp-p denotes a peak-to-peak value corresponding to the sine wave in the reflection electrical signal, i.e., a difference between a peak and a valley in the reflection electrical signal.

Exemplarily, referring to FIG. 4 again, one driving period T includes two excitation storage periods T1s. During one excitation storage period T1, the number of the sine wave cycles of the excitation electrical signal and the reflection electrical signal are 2.5, i.e., N=5.

In an ideal state, a single excitation has sufficient excitation duration. The excitation electrical signal has x sine wave periods under a single excitation, and the reflection electrical signal converted by the ultrasonic signal reflected back also has x sine wave periods. After the reflection electrical signal charges the second node N2 once, the voltage variation of the second node N2 can reach a standard voltage variation 0.5Vₚ₋ₚ corresponding to the fingerprint valleys or fingerprint ridges. At this time, after the reflection electrical signal with a single cycle charges the second node N2, the voltage variation V₀ of the second node N2 satisfies V₀=0.5Vₚ₋ₚ/x.

In the related art, since time for a single excitation is short, the excitation electrical signal has only y periods of sine wave under a single excitation, where y<x. Correspondingly, the reflection electrical signal generated also has only y periods of sine wave. After the reflection electrical signal charges the second node N2, the voltage variation y×0.5Vₚ₋ₚ/x collected by the second node N2 is substantially smaller than 0.5Vₚ₋ₚ, so that it is difficult to accurately recognize the fingerprint valleys and ridges.

In an embodiment of the present disclosure, a sum N of the cycle number of sine wave of the reflection electrical signal during the n excitation storage periods T1s satisfies N×V₀≥0.5Vₚ₋ₚ, that is, N is greater than or equal to x. Therefore, it can be ensured that after n reflection electrical signals generated by n excitations accumulatively charge the second node N2, the voltage variation of the second node N2 can reach the standard voltage variation corresponding to the fingerprint valleys or fingerprint ridges under the ideal state, so that the fingerprint valleys or fingerprint ridges can be accurately recognized according to voltage variation, further improving the fingerprint recognition accuracy.

In an embodiment of the present disclosure, referring to FIG. 4 and FIG. 6 again, the excitation period t1 includes an effective excitation sub-period t11 and an excitation stagnation sub-period t12. During the effective excitation sub-period t11, the excitation signal line TX transmits an excitation electrical signal. During the excitation stagnation sub-period t12, the excitation signal line TX stops transmitting the excitation electrical signal.

In an embodiment of the present disclosure, referring to FIG. 5, during the effective excitation sub-period t11, the first transistor M1 is turned on under the turn-on signal provided by the first control signal line Clamp, and a low-potential driving signal provided by the pull-up signal line Vcom1 is transmitted to the second electrode 12 of the ultrasonic sensor 2 through the first transistor M1 turned on. When driven by the first electrode 11 and the second electrode 12, the piezoelectric layer 13 of the ultrasonic sensor 2 converts the excitation electrical signal transmitted by the excitation signal line TX into an ultrasonic signal, and radiates toward the finger. During the excitation stagnation sub-period t12, the excitation signal line TX stops transmitting the excitation electrical signal, so that the first transistor M1 is turned off, and the first transistor M1 stops transmitting signal to the first node N1.

If the excitation electrical signal directly enters the storage period t2 after it is transmitted by the excitation signal line TX, there can be a situation in which the reflection ultrasonic signals enter the storage period t2 before all of the reflection ultrasonic signals reach the ultrasonic sensor 2. At this time, there are few effective pulses of the reflection ultrasonic signals reflected back, so that a deviation of signal intensity of the converted reflection electrical signal occurs. In an embodiment of the present disclosure, by setting one excitation stagnation sub-period t12 after the effective excitation sub-period t11, enough time can be reserved for the ultrasonic signal reflected back to pass through the display module 6 to the ultrasonic sensor 2, so that the ultrasonic signal reflected back can enter the storage phase after all ultrasonic signals reach the ultrasonic sensor 2. In addition, the excitation stagnation sub-period t12 is an interval period between the effective excitation sub-period t11 and the storage period t2, so that the signal superimposition interference between the effective excitation sub-period t11 and the storage period t2 can be avoided, thereby improving the working reliability of various structures of the circuit during the effective excitation sub-period t11 and the storage period t2.

During the effective excitation sub-period t11, if the number of the sine wave cycles of the excitation electrical signal is N1, the duration of the effective excitation sub-period t11 is N1/F, and F is a frequency of the sine wave in the excitation electrical signal. In an embodiment of the present disclosure, the duration of the effective excitation sub-period t11 can be set to be several hundred nanoseconds, and the total duration of the n excitation storage periods T1s can be set to be several microseconds.

In an embodiment of the present disclosure, the effective excitation sub-periods t11 of the n excitation storage periods T1s last for a same duration. At this time, the ultrasonic signals reflected back have the same number of effective pulses in excitation storage period T1, and the voltage variation of the second node N2 after each charge is the same. In this driving mode, the total durations of excitation storage periods T1 tend to be the same, so that the design is not complex, and it is liable to control.

In an embodiment of the present disclosure, the durations of the effective excitation sub-periods t11 of the n excitation storage periods T1s increase. At this time, the numbers of effective pulses of the ultrasonic signals reflected back during the n excitation storage periods T1s also increase, and the voltage variation of the second node N2 after the reflection electrical signal generated by a previous excitation charges the second node N2 is smaller than the voltage variation of the second node N2 after the reflection electrical signal generated by a subsequent excitation charges the second node N2. In this driving mode, the later the excitation, the greater the potential variation of second node N2, and then the smaller the number of excitations are required in an entire driving cycle T.

In an embodiment of the present disclosure, during the excitation storage period T1, a duration m2 of the effective excitation sub-period t11 and a duration m3 of the storage period t2 satisfy m2≤m3≤1.2×m2, e.g., m3=m2.

During one excitation storage period T1, the excitation electrical signal and the reflection electrical signal have the same cycle number and frequency of sine wave, while only having different signal amplitude. By setting a minimum value m3 to be m2, the duration of the storage period t2 can be at least equal to the duration of the effective excitation sub-period t11, so that the sine wave of each cycle in the reflection electrical signal can charge for the second node N2. Since the reflection electrical signal can be significantly attenuated after L1 period of time, m3 does not need to be too large. The charging can be stopped after a duration of 1.2×m2, so that an entire excitation storage period T1 is prevented from being excessively long, thereby shortening the time of the driving cycle T, and improving the recognition efficiency.

In an embodiment of the present disclosure, referring to FIG. 5 again, the control sub-circuit 3 includes a first transistor M1. A control electrode of the first transistor M1 is electrically connected to the first control signal line Clamp. A first electrode of the first transistor M1 is electrically connected to a pull-up signal line Vcom1, and a second electrode of the first transistor M1 is electrically connected to the first node N1.

During the storage period t2, the first control signal line Clamp provides a turn-on signal for controlling the first transistor M1 to be turned on, and the pull-up signal line Vcom1 provides a pull-up signal for pulling up the potential of the second node N2. A pull-up level of the pull-up signal and a turn-on level of the turn-on signal have the same potential.

During the storage period t2, when the turn-on signal is used to control the first transistor M1 to be turned on, by making the pull-up voltage level of the pull-up signal be equal to the turn-on level of the turn-on signal, the first transistor M1 can be in a state similar to the forward conduction state of a diode, so that the current of the first node N1 can be prevented from leaking toward the first electrode of the first transistor M1, thereby improving the stability of the potential of the first node N1.

In an embodiment of the present disclosure, referring to FIG. 4 and FIG. 6 again, the excitation storage period T1 further includes an interval period t3. The interval period t3 follows after the storage period t2. During the interval period t3, the control sub-circuit 3 stops pulling up the potential of the first node N1.

In an embodiment of the present disclosure, in combination with FIG. 5, in the excitation storage t3, the first control signal line Clamp provides a turn-off signal, the first transistor M1 is turned off, and stops transmitting the pull-up signal to the first node N1. During the interval period t3, the signal transmitted by the pull-up signal line Vcom1 is set to be low to prepare for the excitation period t1 in the next excitation storage period T1.

By setting an interval period t3 in the excitation storage period T1, the storage period t2 in the previous excitation storage period T1 can be divided from the excitation period t1 in the subsequent excitation storage period T1. After the previous excitation storage period T1 finishes charging for the second node N2 by using the reflection electrical signal, it enters the next excitation storage period T1 after a period of time, so that the storage period t2 of the previous excitation storage period T1 can be prevented from superimposing the excitation period t1 of the subsequent excitation storage period T1, that would otherwise result in crosstalk in the signals of the two periods. For example, if the storage period t2 of the previous excitation storage period T1 directly enters the excitation period t1 in the subsequent excitation storage period T1 after it ends, the signal provided by the pull-up signal line Vcom1 cannot be set to be low in time, thereby affecting the working state of the ultrasonic sensor 2, which can be avoided after the interval period t3 is set in this embodiment of the present disclosure.

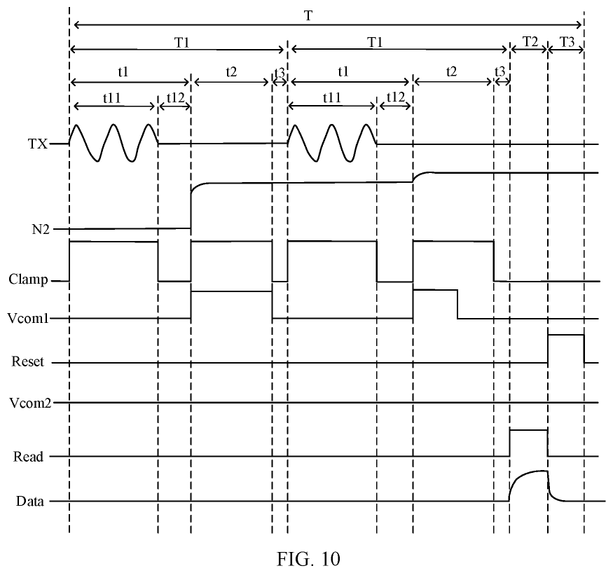

FIG. 9 is a schematic diagram showing a fingerprint recognition circuit according to another embodiment of the present disclosure. In an embodiment of the present disclosure, as shown in FIG. 9, the fingerprint recognition circuit 1 further includes a reset sub-circuit 7. FIG. 10 is a sequence diagram corresponding to FIG. 9 according to an embodiment of the present disclosure. Based on this, as shown in FIG. 10, the driving cycle T also includes a reset period T3. The reset period T3 is located after the read period T2. During the reset period T3, the reset sub-circuit 7 resets the second node N2.

In an embodiment of the present disclosure, referring to FIG. 9 again, the reset sub-circuit 7 includes a fifth transistor M5. A control electrode of the fifth transistor M5 is electrically connected to the reset control signal line Reset. A first electrode of the fifth transistor M5 is electrically connected to the reset signal line Vcom2. A second electrode of the fifth transistor M5 is electrically connected to the second node N2. During the reset period T3, the reset control signal line Reset provides a turn-on signal to control the fifth transistor M5 to be turned on. The reset signal provided by the reset signal line Vcom2 is transmitted to the second node N2 through the fifth transistor M5 turned on, to reset the second node N2.

By resetting the potential of the second node N2 to an initial potential before each driving cycle T ends, it is possible to prevent the second node N2 from retaining the potential of the previous driving cycle Tin the next driving cycle T. Therefore, in the next driving cycle T, the second node N2 starts to be charged from the initial potential, thereby improving the charging accuracy of the second node N2.

Based on the same concept, the present disclosure further provides a display panel. Referring to FIG. 2 and FIG. 3 again, the display panel includes a fingerprint recognition circuit 1. The fingerprint recognition circuit 1 includes a first node N1, a second node N2, an ultrasound sensor 2, a control sub-circuit 3, and a read sub-circuit 4.

The ultrasonic sensor 2 is electrically connected to the excitation signal line TX and the first node N1. The ultrasonic sensor 2 is configured to convert the excitation electrical signal transmitted by the excitation signal line TX into an ultrasonic signal and radiate it toward the finger, and convert the ultrasonic signal reflected by the finger into a reflection electrical signal and transmit it to the first node N1.

The control sub-circuit 3 is electrically connected to the first control signal line Clamp, the pull-up signal line Vcom1, the first node N1, and the second node N2, and is configured to transmit the pull-up signal to the first node N1, and to transmit the signal of the first node N1 to the second node N2.

The read sub-circuit 4 is electrically connected to the second node N2, the first fixed potential signal line AVDD, the read control signal line Read, and the read signal line Data, and is configured to transmit the signal reflecting the size of the voltage of the second node N2, to the read signal line Data.

With reference to FIG. 4, one driving cycle T for fingerprint recognition of the display panel includes n excitation storage periods T1s and a reading period T2. Then excitation storage periods T1s are prior to the reading period T2, where n is a positive integer greater than or equal to 2. The excitation storage period T1 includes an excitation period t1 and a storage period t2. The working process of the fingerprint recognition circuit 1 during each period has been described in detail in the above-mentioned embodiments, and will not be repeated herein.

Referring to FIG. 2 again, the display panel includes a display region 8. The display region 8 includes a fingerprint recognition region 9. The fingerprint recognition circuit 1 is located in the fingerprint recognition region 9. The fingerprint recognition region 9 may be reused as only a part of the display region 8. For example, referring to FIG. 2 again, the fingerprint recognition region 9 is reused as a part of the bottom region of the display region 8. In another embodiment, the fingerprint recognition region 9 can also be reused as the entire region of the display region 8.

In an embodiment of the present disclosure, multiple sets of excitation electrical signals can be used to excite the ultrasonic sensor 2 multiple times within one driving cycle T, and then the second node N2 can be cumulatively charged by using the reflection electrical signals generated multiple times to make the final signal intensity of the second node N2 reaches the standard intensity corresponding to the fingerprint valleys or fingerprint ridges, so that the fingerprint valleys or fingerprint ridges can be accurately detected, thereby improving the fingerprint recognition accuracy. In the embodiments of the present disclosure, the fingerprint recognition accuracy is no longer limited by the thickness of the display module. Even if the above display panel is applied to an ultra-thin display apparatus, high recognition accuracy can be achieved. Therefore, the embodiments of the present disclosure are more suitable for fingerprint recognition of ultra-thin display apparatuses, thereby having a good application prospect.

In an embodiment of the present disclosure, referring to FIG. 5 and FIG. 6 again, the control sub-circuit 3 includes a first transistor M1 and a communication control structure 5. A control electrode of the first transistor M1 is electrically connected to the first control signal line Clamp, a first electrode of the first transistor M1 is electrically connected to the pull-up signal line Vcom1, and a second electrode of the first transistor M1 is electrically connected to the first node N1. The communication control structure 5 is electrically connected between the first node N1 and the second node N2.

In an embodiment of the present disclosure, during the excitation period t1 of the excitation storage period T1, the first transistor M1 is turned on under the turn-on signal provided by the first control signal line Clamp, and a low potential driving signal provided by the pull-up signal line Vcom1 is transmitted to the first node N1 (the second electrode 12 of the ultrasonic sensor 2) through the first transistor M1 turned on, so that the piezoelectric layer 13 of the ultrasonic sensor 2 is driven by the first electrode 11 and the second electrode 12 to convert the excitation electrical signal transmitted by the excitation signal line TX into an ultrasonic signal that is radiated toward the finger.

During the storage period t2 of the excitation storage period T1, the first transistor M1 is turned on under the turn-on signal provided by the first control signal line Clamp, and the pull-up signal provided by the pull-up signal line Vcom1 passes through the first transistor M1 turned on to be transmitted to the first node N1, and the potential of the first node N1 is pulled up to be high. The communication control structure 5 transmits the signal of the first node N1 to the second node N2 through the communication control structure 5. The signals transmitted to the second node N2 include reflection electrical signals and pull-up signals.

The above pull-up signal is configured to control the third transistor M3 of the read sub-circuit 4 to be in a saturation state. In an embodiment of the present disclosure, the reflection electrical signal converted by the ultrasonic signal is not directly used to pull up the potential of the second node N2 to the potential required for the third transistor M3 to be in a saturation state, but a pull-up signal is used alone to pull up the potential of the second node N2 to the potential required for the third transistor M3 to be in a saturation state. In this way, the transistor state of the third transistor M3 is independent from the magnitude of the reflection electrical signal fed back, thereby achieving a higher control reliability of the working state of the third transistor M3.

Referring to FIG. 5 again, the communication control structure 5 includes a diode D. An anode of the diode D is electrically connected to the first node N1, and a cathode of the diode D is electrically connected to the second node N2, so that the pull-up signal and the reflection electrical signal of the first node N1 is transmitted to the second node N2 through the diode D, and the reflection electrical signal is stored, thereby achieving cumulatively charging the second node N2 by the reflection electrical signal after multiple excitations. The diode D has a unidirectional conduction characteristic, so that the current of the second node N2 can be prevented from leaking toward the first node N1, thereby improving the potential stability of the second node N2.

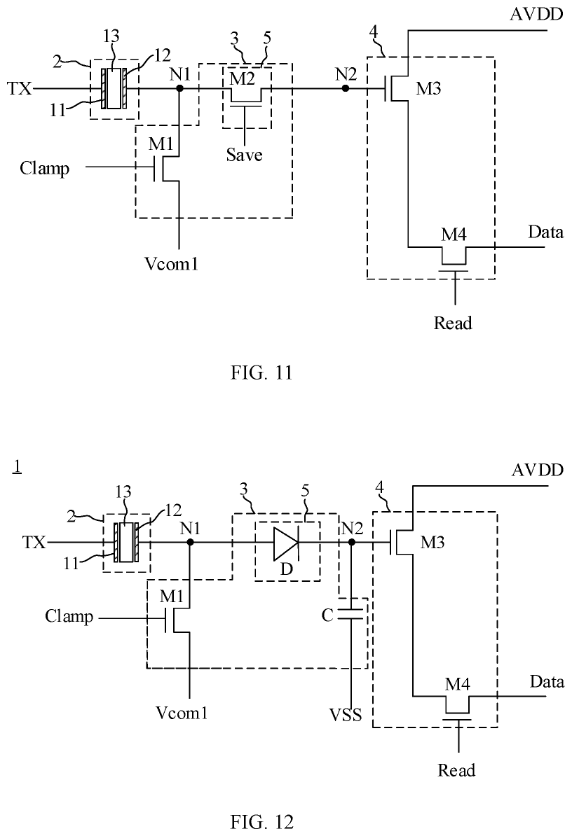

FIG. 11 is a schematic diagram showing a fingerprint recognition circuit according to another embodiment of the present disclosure. As shown in FIG. 11, the communication control structure 5 includes a second transistor M2. A control electrode of the second transistor M2 a is electrically connected to a second control signal line Save, a first electrode of the second transistor M2 is electrically connected to the first node N1, and a second electrode of the second transistor M2 is electrically connected to the second node N2.

During the storage period t2, the second transistor M2 is turned on under a turn-on level provided by the second control signal line Save, a connection path is formed between the first node N1 and the second node N2, so that the signals of the first node N1 are transmitted to the second node N2, thereby charging the second node N2 by the reflection electrical signal.

FIG. 12 is a schematic diagram showing a fingerprint recognition circuit according to another embodiment of the present disclosure. In an embodiment of the present disclosure, as shown in FIG. 12, the control sub-circuit 3 further includes a storage capacitor C. A first electrode plate of the storage capacitor C is electrically connected to a second fixed potential signal line VSS, and a second plate of the storage capacitor C is electrically connected to the second node N2, so that the potential of the second node N2 is stabilized by the storage capacitor C, thereby improving the potential reliability of the second node N2.

In an embodiment of the present disclosure, referring to FIG. 5 and FIG. 6 again, the read sub-circuit 4 includes a third transistor M3 and a fourth transistor M4. A control electrode of the third transistor M3 is electrically connected to the second node N2, a first electrode of the third transistor M3 is electrically connected to the first fixed potential signal line AVDD. A control electrode of the fourth transistor M4 is electrically connected to the read control signal line Read, a first electrode of the fourth transistor M4 is electrically connected to the second electrode of the third transistor M3, and a second electrode of the fourth transistor M4 is electrically connected to the read signal line Data.

In an embodiment of the present disclosure, during the storage period t2, the pull-up signal pulls up a gate potential of the third transistor M3 to control the third transistor M3 to be in a saturation state. At this time, the source-drain current I_{ds} of the third transistor M3 is independent from the source-drain voltage V_{ds}, and only increases with the increase of the gate-source voltage V_{gs}. In this situation, when the potential of the second node N2 is high, the gate-source voltage V_{gs} of the third transistor M3 is large. Correspondingly, the current transmitted from the third transistor M3 to the fourth transistor M4 is large. Subsequently, when the fourth transistor M4 is turned on during the reading period T2, the intensity of the signal reflecting the size of the voltage of the second node N2 and read by the read signal line Data is relatively large. When the potential of the second node N2 is low, the gate-source voltage V_{gs} of the third transistor M3 is small, and accordingly, the current transmitted from the third transistor M3 to the fourth transistor M4 is also small, so that the intensity of the signal reflecting the size of the voltage of the second node N2 and read by the read signal line Data is small. The fingerprint valleys or fingerprint ridges is determined according to the signal intensity that reflects the size of the voltage of the second node N2 and that is read by the read signal line Data.

In an embodiment of the present disclosure, referring to FIG. 9 and FIG. 10 again, the fingerprint recognition circuit 1 further includes a reset sub-circuit 7. The reset sub-circuit 7 is electrically connected to the reset control signal line Reset, the reset signal line Vcom2, and the second node N2, to reset the second node N2. By resetting the potential of the second node N2 to an initial potential before each driving cycle T ends, it is possible to prevent the second node N2 from remaining the potential of the previous driving cycle T, in the next driving cycle T. In the next driving cycle T, the second node N2 starts to be charged from the initial potential, thereby improving the charging accuracy of the second node N2.

Referring to FIG. 9 and FIG. 10 again, the reset sub-circuit 7 includes a fifth transistor M5. A control electrode of the fifth transistor M5 is electrically connected to the reset control signal line Reset, a first electrode of the fifth transistor M5 is electrically connected to the reset signal line Vcom2, and a second electrode of the fifth transistor M5 is electrically connected to the second node N2. During the reset period T3, the reset control signal line Reset provides a turn-on signal to control the fifth transistor M5 to be turned on. The reset signal provided by the reset signal line Vcom2 is transmitted to the second node N2 through the fifth transistor M5 turned on, to reset the second node N2.

In an embodiment of the present disclosure, referring to FIG. 7 again, the display panel further includes a display module 6. An ultrasonic sensor is located at a side of the display module 6 facing away from a light-emitting direction of the display panel. In an embodiment of the present disclosure, the fingerprint recognition accuracy is no longer limited by the thickness of the display module 6, so that the present disclosure can set the thickness of the display panel to be thinner, which is more suitable for application in ultra-thin display apparatuses.

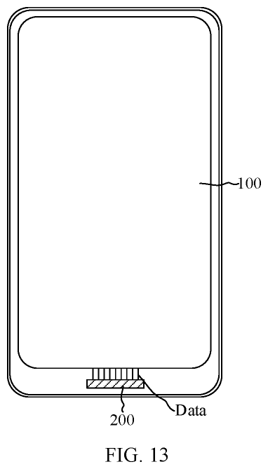

FIG. 13 is a schematic diagram showing a display apparatus according to an embodiment of the present disclosure. Based on the same concept, the present disclosure also provides a display apparatus, as shown in FIG. 13, the display apparatus includes the display panel 100 and a processor 200. The structure of the display panel 100 has been described in detail in the above embodiments, and will not be repeated herein. The processor 200 is electrically connected to the read signal line Data, and is configured to recognize fingerprints according to a signal read by the read signal line Data.

It should be noted that the display apparatus shown in FIG. 13 is only a schematic illustration. The display apparatus according to the present disclosure can be any electronic device having a display function, such as a mobile phone, a tablet computer, a laptop computer, an electronic paper book, or a television.

The above are merely some embodiments of the present disclosure, which, as mentioned above, are not intended to limit the present disclosure. Within the principles of the present disclosure, any modification, equivalent substitution, improvement shall fall into the protection scope of the present disclosure.

Finally, it should be noted that the technical solutions of the present disclosure are illustrated by the above embodiments, but not intended to be limited thereto. Although the present disclosure has been described in detail with reference to the foregoing embodiments, those skilled in the art can understand that the present disclosure is not limited to the specific embodiments described herein, and can include various obvious modifications, readjustments, and substitutions without departing from the scope of the present disclosure.

What is claimed is:

1. A fingerprint recognition method for a display panel, the display panel comprising a fingerprint recognition circuit, wherein the fingerprint recognition circuit comprises a first node, a second node, an ultrasonic sensor electrically connected to an excitation signal line and the first node, a control sub-circuit electrically connected to the first node and the second node, and a read sub-circuit electrically connected to the second node and a read signal line;
wherein a driving cycle for fingerprint recognition of the display panel comprises n excitation storage periods and a read period, wherein the n excitation storage periods are prior to the read period, where n is a positive integer greater than or equal to 2; and each of the n excitation storage periods comprises an excitation period and a storage period;
wherein the fingerprint recognition method comprises:
during the excitation period of the excitation storage period, converting, by the ultrasonic sensor, an excitation electrical signal transmitted by the excitation signal line into an ultrasonic signal, and radiating the ultrasonic signal toward a finger;
during the storage period of the excitation storage period, converting, by the ultrasonic sensor, an ultrasonic signal reflected by the finger into a reflection electrical signal, transmitting, by the ultrasonic sensor, the reflection electrical signal to the first node, transmitting, by the control sub-circuit, a pull-up signal to the first node, and transmitting, by the control sub-circuit, a signal of the first node to the second node; and
during the reading period, transmitting, by the read sub-circuit, a signal that reflects a size of a voltage of the second node, to the read signal line.

2. The fingerprint recognition method according to claim 1, wherein the display panel further comprises a display module, and the ultrasonic sensor is located at a side of the display module facing away from a light-emitting direction of the display panel; and
in one of the n excitation storage periods, a duration m1 of the excitation period satisfies m1≥2D/V, where D denotes a thickness of the display module, and V denotes a speed at which the ultrasonic signal is transmitted in the display module.

3. The fingerprint recognition method according to claim 1, wherein each of the excitation electrical signal and the reflection electrical signal is a sine wave signal; and
wherein N×V₀≥0.5Vₚ₋ₚ, where N denotes a total number of sine wave cycles of the reflection electrical signal in the n excitation storage periods, V₀ denotes a voltage variation of the second node when a single sine wave cycle of the reflection electrical signal is transmitted to the second node, and Vₚ₋ₚ denotes a peak-to-peak value corresponding to a sine wave of the reflection electrical signal.

4. The fingerprint recognition method according to claim 1, wherein the excitation period comprises an effective excitation sub-period and an excitation stagnation sub-period, wherein during the effective excitation sub-period, the excitation signal line transmits the excitation electrical signal; and during the excitation stagnation sub-period, the excitation signal line stops transmitting the excitation electrical signal.

5. The fingerprint recognition method according to claim 4, wherein the effective excitation sub-periods of the excitation periods of the n excitation storage periods each last for a same duration.

6. The fingerprint recognition method according to claim 4, wherein the effective excitation sub-periods of the excitation periods of the n excitation storage periods increase.

7. The fingerprint recognition method according to claim 4, wherein in one of the n excitation storage periods, a duration m2 of the effective excitation sub-period and a duration m3 of the storage period satisfy m2≤m3≤1.2×m2.

8. The fingerprint recognition method according to claim 1, wherein the control sub-circuit comprises a first transistor, wherein the first transistor comprises a control electrode electrically connected to a first control signal line, a first electrode electrically connected to a pull-up signal line, and a second electrode electrically connected to the first node; and
during the storage period, the first control signal line provides a turn-on signal for turning on the first transistor to be turned on, and the pull-up signal line provides a pull-up signal for pulling up a potential of the second node, and a pull-up voltage level of the pull-up signal has a same potential as a turn-on voltage level of the turn-on signal.

9. The fingerprint recognition method according to claim 1, wherein each of the n excitation storage periods further comprises an interval period, wherein the interval period follows after the storage period, and wherein the control sub-circuit stops pulling up a potential of the first node during the interval period.

10. The fingerprint recognition method according to claim 1, wherein the fingerprint recognition circuit further comprises a reset sub-circuit; and
the driving cycle further comprises a reset period following after the read period, and the reset sub-circuit resets the second node during the reset period.

11. A display panel, comprising:
a fingerprint recognition circuit,
wherein the fingerprint recognition circuit comprises:
a first node;
a second node;
an ultrasonic sensor electrically connected to both an excitation signal line and the first node, wherein the ultrasonic sensor is configured to: convert an excitation electrical signal transmitted by the excitation signal line into an ultrasonic signal, radiate the ultrasonic signal toward a finger, convert an ultrasonic signal reflected by the finger into a reflection electrical signal, and transmit the reflection electrical signal to the first node;
a control sub-circuit electrically connected to a first control signal line, a pull-up signal line, the first node, and the second node, wherein the control sub-circuit is configured to transmit a pull-up signal to the first node and to transmit a signal of the first node to the second node; and
a read sub-circuit electrically connected to the second node, a first fixed potential signal line, a read control signal line, and a read signal line, wherein the read sub-circuit is configured to transmit a signal that reflects a size of a voltage of the second node, to the read signal line.

12. The display panel according to claim 11, wherein the control sub-circuit comprises:
a first transistor, wherein the first transistor comprises a control electrode electrically connected to the first control signal line, a first electrode electrically connected to the pull-up signal line, and a second electrode electrically connected to the first node; and
a communication control structure electrically connected between the first node and the second node.

13. The display panel according to claim 12, wherein the communication control structure comprises a diode, wherein the diode comprises an anode electrically connected to the first node, and a cathode electrically connected to the second node.

14. The display panel according to claim 12, wherein the communication control structure comprises a second transistor, wherein the second transistor comprises a control electrode electrically connected to a second control signal line, a first electrode electrically connected to the first node, and a second electrode electrically connected to the second node.

15. The display panel according to claim 12, wherein the control sub-circuit further comprises a storage capacitor, wherein the storage capacitor comprises a first plate electrically connected with a second fixed potential signal line, and a second plate electrically connected with the second node.

16. The display panel according to claim 11, wherein the read sub-circuit comprises:
a third transistor, wherein the third transistor comprises a control electrode electrically connected to the second node, and a first electrode electrically connected to the first fixed potential signal line; and
a fourth transistor, wherein the fourth transistor comprises a control electrode electrically connected to the read control signal line, a first electrode electrically connected to the second electrode of the third transistor, and a second electrode electrically connected to the read signal line.

17. The display panel according to claim 11, wherein the fingerprint recognition circuit further comprises:
a reset sub-circuit, wherein the reset sub-circuit is electrically connected to a reset control signal line, a reset signal line, and the second node, and the reset sub-circuit is configured to reset the second node.

18. The display panel according to claim 17, wherein the reset sub-circuit comprises a fifth transistor, wherein the fifth transistor comprises a control electrode electrically connected to the reset control signal line, a first electrode electrically connected to the reset signal line, and a second electrode electrically connected to the second node.

19. The display panel according to claim 11, further comprising:
a display module, wherein the ultrasonic sensor is located at a side of the display module facing away from a light-emitting direction of the display panel.

20. A display apparatus, comprising:
a display panel; and
a processor,
wherein the display panel comprises a fingerprint recognition circuit;
wherein the fingerprint recognition circuit comprises:
a first node,
a second node,
an ultrasonic sensor electrically connected to both an excitation signal line and the first node, wherein the ultrasonic sensor is configured to convert an excitation electrical signal transmitted by the excitation signal line into an ultrasonic signal, radiate the ultrasonic signal toward a finger, convert an ultrasonic signal reflected by the finger into a reflection electrical signal and transmit the reflection electrical signal to the first node,
a control sub-circuit electrically connected to a first control signal line, a pull-up signal line, the first node, and the second node, wherein the control sub-circuit is configured to transmit a pull-up signal to the first node and to transmit a signal of the first node to the second node, and
a read sub-circuit electrically connected to the second node, a first fixed potential signal line, a read control signal line, and a read signal line, wherein the read sub-circuit is configured to transmit to the read signal line a signal that reflects a size of a voltage of the second node; and
wherein the processor is electrically connected to the read signal line and is configured to recognize fingerprints based on a signal read by the read signal line.
